(19) United States
(12) Patent Application Publication
(10) Pub. No.: US 2002/0099619 A1
(43) Pub. Date: Jul. 25, 2002

(54) Supply system of compound for chemical vapor deposition and thin - film manufacturing system having the same compound supply system

(75) Inventor: Koji Okamoto, Kanagawa (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: TANAKA KIKINZOKU KOGYO K.K.

(21) Appl. No.: 10/046,753

(22) Filed: Jan. 17, 2002

(30) Foreign Application Priority Data
Jan. 22, 2001 (JP) 2001-012942

(51) Int. Cl. G06F 17/60

(52) U.S. Cl. 705/26; 705/28; 700/123

(57) ABSTRACT

A supply system of a compound for CVD is provided with not only an order-processing device, an inventory data base, and a charging-processing device but also an analyzing unit having an analysis information output unit capable of analyzing a spent compound that is returned from a customer, and outputting, as analysis information, at least a weight of an unreacted compound in the spent compound; a regenerating unit having a regeneration information output unit for separating an unreacted compound from a spent compound and refining a separated unreacted compound, and for outputting, as regeneration information, at least an amount of regenerated compound; and a stock-material information database for storing shipment information of the spent compound at the time of initial shipment. When a shipment request comes from a customer, an order-processing device judges whether shipment is possible based on the information of an inventory data base and performs shipment processing if the shipment is possible. When the spent compound is returned from the customer, the charging-processing device calculates an amount of compound consumed by the customer and performs charging-processing for the customer. The inventory data base extracts an amount of regenerated compound from regeneration information that is output from the regeneration information output unit, and stores the amount of regenerated compound as an amount of shippable compound.

### BACKGROUND OF THE INVENTION

1. Field of the Invention

The present invention relates to a system for supplying an organic metal compound to a customer that manufactures metal thin films. In particular, the invention relates to a system for processing a spent compound that is returned from a customer into a reusable state (recycling) and supplying the reusable compound to the customer.

2. Description of the Related Art

Nowadays, the chemical vapor deposition (hereinafter referred to as CVD) is widely used in manufacture of thin-film electrodes of semiconductor devices. In general, the CVD is such that an organic metal compound which becomes material is vaporized and reaction of a resulting material gas is caused above a substrate, whereby a thin film is formed on the substrate to manufacture a uniform film. The CVD enables manufacture of a uniform coating. Having an advantage of superior step coverage, the CVD can satisfy the recent requirement of increase in the densities of circuits and electronic parts and hence is used in a number of semiconductor device makers as a thin film forming technique.

Organic metal compounds as material of the CVD should have high purity and many of them are difficult to synthesize. It is a general procedure that a semiconductor device maker is supplied with an organic metal material from a compound manufacturer.

Incidentally, the cost of manufacture of a thin film using the CVD depends on the ratio of the amount of compound consumed by the reaction to the amount of compound used, that is, the efficiency of utilization. The efficiency of utilization of the CVD is as low as 10% or less and actually most of a material gas introduced is disposed of as a waste gas. The organic metal compound in the waste gas is discarded even if it was not subjected to reaction. It is inevitable that the thin-film manufacturing cost with such low efficiency of utilization is high, which is a current situation.

In view of the above circumstances, from the standpoint of a manufacturer of a material compound, the present inventors developed a technique of separating an unreacted compound from a spent compound occurring in thin film manufacture and refining it into a reusable state. Specifically, this recycling technique is such that a spent compound is subjected to prescribed preprocessing, then distilled under particular conditions, and finally refined by extracting a solvent (for the details of this technique, refer to Japanese Patent Application Nos. 2000-96359 and 2000-235092).

The possibility and the method of such recycling of a CVD material were unknown until the inventors established the above recycling technique. Until that time, the roles of a material manufacturer were only synthesizing a new compound and supplying it to a thin film manufacturer. To reduce the thin-film manufacturing cost of a thin film manufacturer and use resources effectively by utilizing the above recycling technique effectively, the inventors have conceived two kinds of supply methods of a compound for CVD.

In the first supply method, a spent compound that is returned from a customer is subjected to regeneration and a regenerated compound is returned to a stock. The customer is charged for the amount of compound supplied minus the amount of unreacted compound, that is, the amount of compound that was consumed actually by the customer.

In the second supply method, after a spent compound that is returned from a customer is subjected to regeneration and a regenerated compound is returned directly to the customer, the customer is charged for a regeneration cost. The second supply system is the same as the first supply system in that a regenerated compound is managed. However, in the second supply method, the supplier side supplies a regenerated compound directly to the thin film manufacturer without storing it.

Naturally, conventional supply systems in which a new compound is merely manufactured and shipped while being stocked cannot accommodate the above two kinds of supply methods of a compound for CVD.

### SUMMARY OF THE INVENTION

The present invention has been achieved in the above circumstances, and an object of the invention is therefore to provide a new supply system that makes it possible to efficiently practice the above-described two kinds of novel supply methods that incorporate the above-described recycling technique.

To attain the above object, a supply system of a compound for chemical vapor deposition that has been developed by the present inventors and can accommodate the first supply method comprises an order-processing device for receiving a request for shipment of a compound for chemical vapor deposition from a customer, and for performing shipment processing; an inventory data base for storing an amount of shippable compound; analyzing means having analysis information output means capable of analyzing a spent compound that is returned from the customer, and outputting, as analysis information, at least a weight of an unreacted compound in the spent compound; regenerating means having regeneration information output means for separating the unreacted compound from the spent compound and refining the separated unreacted compound, and for outputting, as regeneration information, at least an amount of regenerated compound; a stock-material information database for storing shipment information of the spent compound at the time of initial shipment; and a charging-processing device for performing charging-processing for the customer, wherein when a shipment request comes from the customer, the order-processing device judges whether shipment is possible by comparing the amount of shippable compound that is stored in the inventory data base with an order amount of the customer, and performs shipment processing if the shipment is possible; and wherein after a spent compound is returned from the customer, the charging-processing device calculates an amount of compound consumed by the customer based on analysis information that is output from the analysis information output means and performs charging-processing for the customer, and the inventory data base extracts an amount of regenerated compound from regeneration information that is output from the regeneration information output means and stores the amount of regenerated compound as an amount of shippable compound.

In this first supply system, information that is obtained in the analyzing process and the regenerating process for a spent compound returned from a customer is managed each time and utilized effectively, whereby the stock management and the charging-processing for the customer can be performed efficiently.

In this supply system, a conventional manufacturing line of a compound manufacturer is not indispensable. That is, this supply system may be such that the supply system does not manufacture a new compound by itself and, instead, stores a compound manufactured by another manufacturer and supplies it to a thin film manufacturer, and that the supply system merely performs regeneration of a spent compound. However, this supply system can increase the total efficiency of manufacture and regeneration of a material compound when integrated with the conventional manufacturing line.

A supply system of a compound for chemical vapor deposition that can accommodate the second supply method comprises an order-processing device for receiving a regeneration request from a customer; regenerating means having regeneration information output means for separating an unreacted compound from a spent compound returned from the customer and refining the separated unreacted compound, and for outputting, as regeneration information, at least a weight of a regenerated compound; a regeneration cost database in which a regeneration cost per unit weight corresponding to a kind of the spent compound returned from the customer is recorded; and a charging-processing device for performing charging-processing for a regeneration cost for the customer, in which the charging-processing device calculates a regeneration cost based on the regeneration information that is output from the regenerating means and the regeneration cost database, and performs charging-processing for the customer, which is set forth in claim 7.

This second supply system is useful in a case that a material supplier has a main role of regeneration of a spent compound and charges a customer for a regenerated compound. That is, this system has the regenerating means as an indispensable component but need not always be provided with analyzing means. Therefore, with the entire system configuration that is simple, this supply system can play the role of regeneration of a spent compound with a low equipment cost.

However, this supply system may be provided with analyzing means. With the analyzing means, information of a spent material can be obtained immediately after its reception (before its being put into the regenerating process). This makes it possible to predict an amount of compound regenerated by the regenerating process and hence to estimate a regeneration cost. Analyzing a spent compound makes it possible to recognize an amount of unreacted compound in the spent compound and its degree of deterioration, which in turn makes it possible to judge, before doing so actually, whether to perform regeneration.

Also in the second supply system, a manufacturing line of a new compound is not indispensable. However, to increase the total efficiency of manufacture and regeneration of a material compound, it is preferable that the this supply system be integrated with a conventional manufacturing line.

### BRIEF DESCRIPTION OF THE DRAWINGS

FIG. 1 is a conceptual diagram of a thin-film manufacturing system according to a first embodiment of the invention;

FIG. 2 is a conceptual diagram of a compound supply system in the first embodiment;

FIG. 3 is a conceptual diagram of a thin-film manufacturing system according to a second embodiment of the invention; and

FIG. 4 is a conceptual diagram of a compound supply system in the second embodiment.

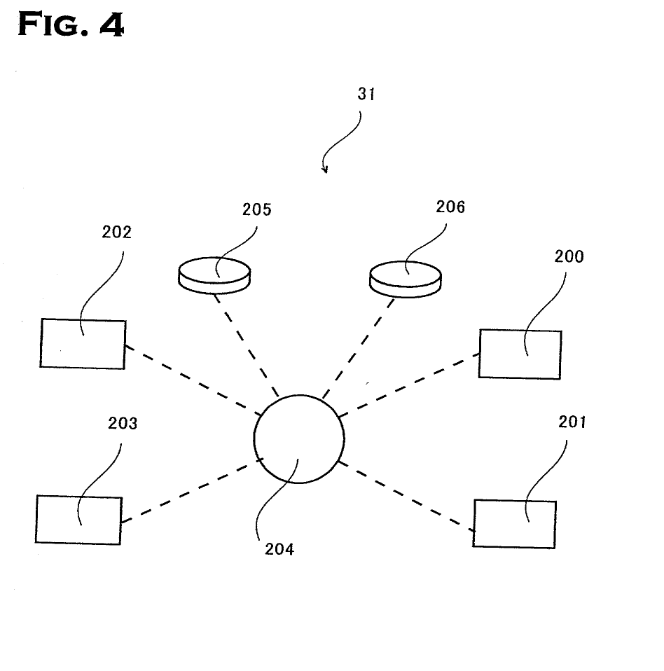

### DETAILED DESCRIPTION OF THE PREFERRED EMBODIMENTS

Preferred embodiments of the present invention will be hereinafter described with reference to the accompanying drawings.

First Embodiment

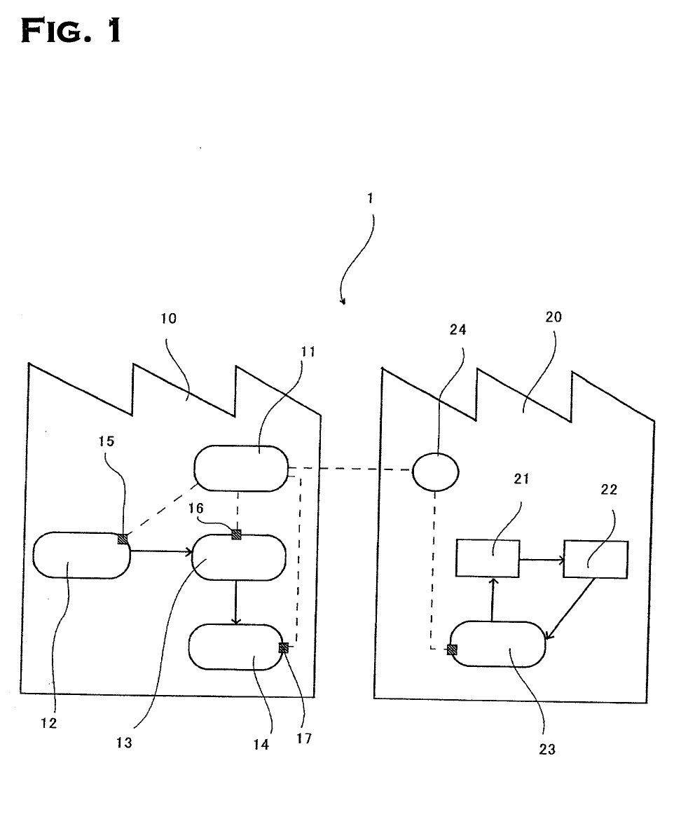

FIG. 1 outlines the concept of a thin-film manufacturing system that includes a first supply system according to the invention. As shown in FIG. 1, a thin-film manufacturing system 1 according to this embodiment is composed of a compound supply section 10 for performing manufacture and regeneration of a material compound and a thin-film manufacturing section 20 that corresponds to a compound user (thin film manufacturer). The compound supply section 10 and the thin-film manufacturing section 20 are connected to each other by a network.

The compound supply section 10 is composed of a supply system 11, a manufacturing section 12 for manufacturing a new compound, a stock management section 13 for storing and managing a compound that is manufactured or regenerated by the manufacturing section 12 and the supply system 11, and a physical distribution section 14 for shipping a compound that is stored in the stock management section 13 and for accepting a spent compound that is returned from the thin-film manufacturing section 20. The manufacturing section 12 is provided with a manufacture management terminal 15 for communicating the amount of new compound manufactured to the supply system 11. The stock management section 13 is provided with a stock management terminal 16 for communicating stock amount data that is information indicating a kind and an amount of stored compound to the supply system 11. The physical distribution section 14 is provided with a physical distribution management terminal 17 for receiving a shipment instruction from the supply system 11 and for notifying the supply system 11 about acceptance of a spent compound returned from the thin-film manufacturing section 20.

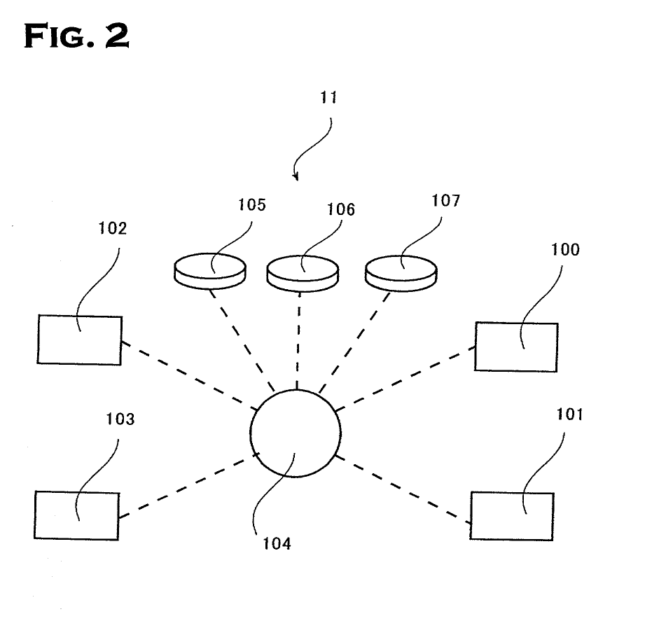

FIG. 2 is a conceptual diagram showing the configuration of the supply system 11. The supply system 11 is composed of an order-processing terminal 100, a charging-processing terminal 101, spent compound analyzing means 102, and regenerating means 103. The terminals 100 and 101 and the means 102 and 103 are network connected to each other via a supply system management server 104.

Each of the terminals 100 and 101 has a central processing unit (CPU), a work memory, and a communication control interface for transmission to and reception from the supply system management server 104. Programs for checking the stock, issuing a shipment instruction, and extracting information that is necessary to perform shipment processing from order information that is received via the supply system management server 104 are stored in the order-processing terminal 100. The charging-processing terminal 101 is provided with a program for calculating an amount of compound consumed by a customer based on analysis information sent from the analyzing means 102 as well as bill forms to be used for charging customers.

The supply system management server 104 is provided with an inventory data base 105 for storing compound stock data that is sent from the stock management terminal 16. The supply system management server 104 is also provided with a customer information database 106 for accumulating information relating to customers and histories of compounds that were supplied to the individual customers as well as a compound cost database 107 in which prices per unit weight of respective organic metal compounds are recorded.

The analyzing means 102 is provided with a gas chromatography measuring apparatus, its control device, and a terminal for calculating a weight, purity, a metal content of an unreacted compound in a spent compound based on analysis results, displaying the calculation results as analysis information, and sending those to the supply system management server 104.

The regenerating means 103 is provided with a reforming tower (a tower charged with a platinum catalyst) for reforming an analyzed spent compound, a distiller for distilling a reformed compound, and a solvent extraction tower for extracting an unreacted compound from a fraction obtained by the distiller and refining it. The regenerating means 103 is also provided with a weight meter for weighing an extracted unreacted compound, a gas chromatography measuring apparatus for checking purity of the extracted unreacted compound and for analyzing its metal content, and its control device, as well as a terminal for calculating a weight, purity, and a metal content of the extracted unreacted compound based on analysis results, displaying the calculation results as regeneration information, and sending those to the management server 104.

On the other hand, the thin-film manufacturing section 20 is provided with a CVD apparatus 21 for manufacturing a thin film, a cold trap 22 for recovering a spent compound by cooling and condensing exhaust of the CVD apparatus 21, and a storage section 23 for storing a compound supplied from the compound supply section 10 and the spent compound recovered by the cold trap 22. The storage amount of compound and the amount of recovered spent compound are always recorded and managed by a management server 24 on the side of the thin-film manufacturing section 20.

Next, a thin-film manufacturing process and a flow of a compound in the thin-film manufacturing system will be described. First, when the amount of compound held by the thin-film manufacturing section 20 becomes insufficient, the management server 24 on the thin-film manufacturing section 20 side orders a new compound by sending information including prescribed order information by e-mail or the like. The order information consists of a kind and an amount of organic metal compound, a desired date of delivery, a delivery location, etc.

Receiving the order, the management server 104 on the side of the compound supply section 10 sends the order information to the order-processing terminal 100. The order-processing terminal 100 extracts necessary order information from the received order information. The order-processing terminal 100 receives a current stock amount from the inventory data base 105 via the management server 104 on the side of the compound supply section 10, and judges whether shipment of the ordered compound is possible. If the shipment is possible, the order-processing terminal 100 instructs the physical distribution section 14 to ship the subject compound. The order-processing terminal 100 gives a proper reference number to the shipped compound, and stores a weight, purity, etc. of the shipped compound as well as its reference number are stored in the customer information database 106.

The amount of the new compound supplied to the thin-film manufacturing section 20 is stored in the management server 24 on the side of the thin-film manufacturing section 20, and then the new compound itself is stored temporarily. The CVD apparatus 21 manufacture thin films and semiconductor products using the new compound. The cold trap 22 recovers a spent compound by cooling exhaust of the CVD apparatus 21. The recovered spent compound is stored in the storage section 23, and its amount is accumulated and recorded by the management server 24 on the side of the thin-film manufacturing section 20.

When the amount of spent compound has reached a prescribed amount, the management server 24 on the side of the thin-film manufacturing section 20 notifies the management server 104 on the side of the compound supply section 10 about return of a spent compound and returns the spent compound to the supply system 10 by proper transport means.

First, the spent compound returned to the supply system 10 is analyzed by the analyzing means 102, whereby a density, a weight, and a metal content of an unreacted compound in the spent compound are quantified. Analysis values are displayed as analysis information, and are sent to the management server 104 on the compound supply section 10 side and recorded in the customer information server 106.

On the other hand, the analyzed spent compound is supplied to the regenerating means 103, where the unreacted compound is separated and refined. A weight and composition of a refined unreacted compound are analyzed, and resulting analysis information is sent to the management server 104 on the side of the compound supply section 10. The amount of the same kind of compound stored in the inventory data base 105 is increased accordingly.

After the execution of the above process, the charging-processing terminal 101 receives, via the management server 104 on the side of the compound supply section 10, the weight and the analysis information of the compound at the time of shipment (the new compound) that is stored in the customer information database 106, calculates an amount of unreacted compound in the spent compound, and determines an amount of compound consumed in the thin-film manufacturing section 20. The charging-processing terminal 101 reads the unit price of the compound from the compound cost database 107 and calculates a cost of the compound corresponding to its consumption by multiplying the amount by the unit price. The charging-processing terminal 101 produces a bill based on a calculation result using a prescribed bill format. The bill is sent to the management server 24 on the side of the thin-film manufacturing section 20 via the management server 104 on the side of the compound supply section 10 by using means such as an e-mail or the like.

In the above-described manners, anew material is shipped, a recovered spent material is analyzed and subjected to regeneration, and a compound cost corresponding to a consumption in the thin-film manufacturing section 20 is charged. When a new material of the same kind is ordered, the same operation as described above is performed. At this time, a stock amount of the material that is stored in the inventory data base 105 includes an amount of unreacted compound that was regenerated by previous regeneration.

Second Embodiment

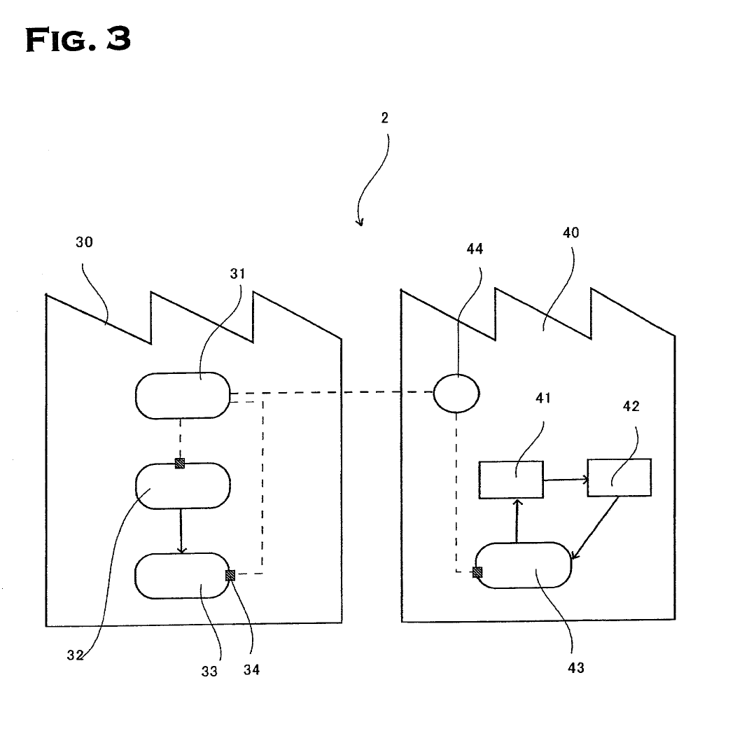

A thin-film manufacturing system including a second supply system according to the invention will be described in this embodiment. As shown in FIG. 3, a thin-film manufacturing system 2 is composed of a compound supply section 30 for performing regeneration of a spent compound and a thin-film manufacturing section 40. As in the case of the first embodiment, the compound supply section 30 and the thin-film manufacturing section 40 are connected to each other by a network.

The compound supply section 30 is composed of a supply system 31, a stock management section 32 for storing a compound that is regenerated by the supply system 31, and a physical distribution section 33 for shipping a regenerated compound that is stored in the stock management section 32 and for accepting a spent compound that is returned from the thin-film manufacturing section 40. The physical distribution section 33 is provided with a physical distribution management terminal 34 for receiving a shipment instruction from the supply system 31 and for notifying the supply system 31 about acceptance of a spent compound returned from the thin-film manufacturing section 40.

The supply system 31 is provided with an order-processing terminal 200, a charging-processing terminal 201, and regenerating means 202. In this embodiment, the supply system 31 is also provided with spent compound analyzing means 203. The terminals 200 and 201 and the means 202 and 203 are network-connected to each other via a management server 204 on the compound supply system side.

As in the case of the first embodiment, each of the terminals 200 and 201 has a central processing unit (CPU), a work memory, and a communication control interface for transmission to and reception from the management server 204 on the side of the compound supply section 30. Programs for receiving a regeneration request from the thin-film manufacturing section 40 via the management server 204 on the side of the compound supply section 30 and for instructing the physical distribution section 33 to ship a compound in response to completion of regeneration of an unreacted compound are stored in the order-processing terminal 200. The charging-processing terminal 201 is provided with a program for calculating a regeneration cost based on regeneration information that is sent from the regenerating means 202 as well as bill forms to be used for charging customers.

On the other hand, the management server 204 on the side of the compound supply section 30 is provided with a regeneration cost database 205 in which regeneration costs per unit weight of respective compounds are recorded. The supply system management server 104 is also provided with a customer information database 206 for storing information relating to customers, and unreacted material regeneration information for each spent compound that was received from each customer, and spent material analysis information.

The regenerating means 202 and the analyzing means 203 in this embodiment are configured in the same manners as the regenerating means 103 and the analyzing means 102 in the first embodiment.

On the other hand, as in the case of the first embodiment, the thin- film manufacturing section 40 is provided with a CVD apparatus 41 for manufacturing a thin film, a cold trap 42 for recovering a spent compound by cooling and condensing exhaust of the CVD apparatus 41, and a storage section 43 for storing the spent compound recovered by the cold trap 42. The amount of recovered spent compound is always recorded and managed by a management server 44 on the side of the thin-film manufacturing section 40.

Next, a flow from use of a new compound to regeneration and a charging process will be described. A compound held by the thin-film manufacturing section 40 is used by the CVD apparatus 41 to manufacture thin films. A spent compound is recovered by the cold trap 42 and stored by the storage section 43. The recovered amount is monitored each time by the management server 44 on the side of the thin-film manufacturing section 40. When the recovered amount has reached a prescribed amount, the management server 44 on the side of the thin-film manufacturing section 40 sends a spent compound regeneration request to the management server 204 on the compound supply section 30 side bye-mail or like means. At the same time, a spent compound is transported to the physical distribution section 33 on the compound supply section 30 side by proper transport means.

In the compound supply section 30 that has received the spent compound, first, the analyzing means 203 analyzes the spent compound. Resulting analysis information is displayed and stored in the customer information database 206 via the management server 204 on the side of the compound supply section 30.

The order-processing terminal 200 produces an analysis report based on the analysis result, and sends it to the management server 44 on the side of the thin-film manufacturing section 40 via the management server 204 on the compound supply section 30 side by e-mail or like means. The order-processing terminal 200 may have a program for predicting a rough amount of regenerated compound based on analysis information and estimating a regeneration cost based on the rough amount of regenerated compound, and produce a written estimate using this program.

Upon receiving the analysis report (or the written estimate) sent from the compound supply section 30, the thin-film manufacturing section 40 considers whether to request regeneration. The above procedure makes it possible to cancel the regeneration request when the spent material is much deteriorated and hence only a small amount of unreacted compound will be regenerated or the regeneration cost is high.

In the compound supply section 30, after the analysis of the spent compound, the regenerating means 202 separates and refines an unreacted compound. The weight and the composition of a refined unreacted compound are analyzed, and resulting regeneration information is sent to the management server 204 on the side of the compound supply section 30 and stored in the customer information database 206. The regenerated unreacted compound is shipped from the physical distribution section 33 to the thin-film manufacturing section 40 and used there again.

After execution of the above process, the charging-processing terminal 201 receives the regeneration information from the customer information database 206 via the management server 204 on the side of the compound supply section 30 and also receives the regeneration cost per unit weight from the regeneration cost database 205. The charging-processing terminal 201 calculates a regeneration cost of the regeneration operation concerned based on the received information. A calculation result is entered in a prescribed bill format, whereby a bill is produced. The bill is sent to the management server 44 on the side of the thin-film manufacturing section 40 via the management server 204 on the side of the compound supply section 30 by e-mail or like means.

In the second embodiment, a regenerated compound supplied to the thin-film manufacturing section 30 is used repeatedly while being recovered. A recovered spent material (of a regenerated material) is again recovered. In this manner, the resource is utilized effectively through its repetitive use.

The invention enables efficient functioning of the novel supply methods of a material compound for CVD that utilize the recycling technique. Specifically, the first supply system according to the invention enables efficient execution of a process that a spent compound that is returned from a customer is subjected to regeneration, a regenerated compound is returned to a stock, and the customer is charged for the amount of compound that was consumed actually by the customer.

On the other hand, the second supply system according to the invention enables efficient execution of a process that after a spent compound that is returned from a customer is subjected to regeneration and a regenerated compound is returned directly to the customer, the customer is charged for a regeneration cost.

What is claimed is:

1. A supply system of a compound for chemical vapor deposition, comprising:
an order-processing device for receiving a request for shipment of a compound for chemical vapor deposition from a customer, and for performing shipment processing;
an inventory database for storing an amount of shippable compound;
analyzing means having analysis information output means capable of analyzing a spent compound that is returned from the customer, and outputting, as analysis information, at least a weight of an unreacted compound in the spent compound;
regenerating means having regeneration information output means for separating the unreacted compound from the spent compound and refining the separated unreacted compound, and for outputting, as regeneration information, at least an amount of regenerated compound;
a stock-material information database for storing shipment information of the spent compound at the time of initial shipment; and
a charging-processing device for performing price charging-processing for the customer,
wherein when a shipment request comes from the customer, the order-processing device judges whether shipment is possible by comparing the amount of shippable compound that is stored in the inventory data base with an order amount of the customer, and performs shipment processing if the shipment is possible, and
after a spent compound is returned from the customer, the charging-processing device calculates an amount of compound consumed by the customer based on analysis information that is output from the analysis information output means and performs charging-processing for the customer, and the inventory data base extracts an amount of regenerated compound from regeneration information that is output from the regeneration information output means and stores the amount of regenerated compound as an amount of shippable compound.

2. The supply system of a compound for chemical vapor deposition according to claim 1,
wherein the analysis information includes a density and composition as well as the weight of the unreacted compound in the spent compound.

3. The supply system of a compound for chemical vapor deposition according to claim 1 or 2,
wherein the regeneration information includes purity and composition of the regenerated compound.

4. The supply system of a compound for chemical vapor deposition according to any one of claims 1 to 3,
wherein the shipment information includes purity and composition of a compound at the time of shipment.

5. The supply system of a compound for chemical vapor deposition according to any one of claims 1 to 4,
wherein the stock-material information database also stores the analysis information and the regeneration information.

6. The supply system of a compound for chemical vapor deposition according to any one of claims 1 to 5,
wherein the order-processing device, the inventory data base, the analyzing means, the regenerating means, the charging-processing device, and the stock-material information database are connected to each other by a network.

7. A supply system of a compound for chemical vapor deposition, comprising:
an order-processing device for receiving a regeneration request from a customer;
regenerating means having regeneration information output means for separating an unreacted compound from a spent compound returned from the customer and refining the separated unreacted compound, and for outputting, as regeneration information, at least a weight of a regenerated compound;
a regeneration cost database in which a regeneration cost per unit weight corresponding to a kind of the spent compound returned from the customer is recorded; and
a charging-processing device for performing charging-processing for a regeneration cost for the customer,
wherein the charging-processing device calculates a regeneration cost based on the regeneration information that is output from the regenerating means and the regeneration cost database, and performs charging-processing for the customer.

8. The supply system of a compound for chemical vapor deposition according to claim 7,
wherein the regeneration information further includes purity and composition of the regenerated compound.

9. The supply system of a compound for chemical vapor deposition according to claim 7 or 8,
wherein the order-processing device, the regenerating means, the charging-processing device, and the regeneration cost database are connected to each other by a network.

10. The supply system of a compound for chemical vapor deposition according to any one of claims 7 to 9, further comprising analyzing means having analysis information output means capable of analyzing the spent compound that is returned from the customer, and outputting, as analysis information, at least a weight of an unreacted compound in the spent compound.

11. The supply system of a compound for chemical vapor deposition according to claims 7 to 9,
wherein the analysis information includes at least one of the weight, a density, and composition of the unreacted compound in the spent compound.

12. The supply system of a compound for chemical vapor deposition according to claims 10 to 11,
wherein the order-processing device, the regenerating means, the charging-processing device, the regeneration cost database, and the analyzing means are connected to each other by a network.

13. A thin-film manufacturing system comprising:
a compound supply section comprising a supply system of a compound for chemical vapor deposition according to any one of claims 1 to 12; and a thin-film manufacturing section for manufacturing a thin film using a compound that is supplied from the supply system, comprising:
a thin-film manufacturing apparatus;
recovering means for recovering a spent compound that is discharged from the thin-film manufacturing apparatus;
a storage device for storing an amount of spent compound recovered by the recovering means; and
ordering-processing device for performing processing of ordering a new compound or processing of issuing a request for regeneration of the recovered spent compound,
wherein the order-processing device of the compound supply section and the ordering-processing device of the thin-film manufacturing section are connected to each other by a network.
